(19) United States
(12) Patent Application Publication
(10) Pub. No.: US 2026/0361953 A1
(43) Pub. Date: Nov. 12, 2026

(54) STUTTERING PROCESSING METHOD, ELECTRONIC DEVICE AND NON-TRANSITORY COMPUTER-READABLE STORAGE MEDIUM

(71) Applicant: Beijing Zitiao Network Technology Co., Ltd., Beijing (CN)

(72) Inventors: Huazhou WEN, Beijing (CN); Lei LAI, Beijing (CN)

(21) Appl. No.: 19/386,139

(22) Filed: Nov. 11, 2025

(30) Foreign Application Priority Data
Nov. 29, 2024 (CN) 202411748424.6

(51) Int. Cl. H04N 21/4402; H04N 21/431

(52) U.S. Cl. CPC H04N 21/440218; H04N 21/4318

(57) ABSTRACT

A stuttering processing method, an electronic device and a non-transitory computer-readable storage medium are disclosed. The method includes: obtaining a material clip in a video editing draft that is configured for rendering a preview frame and corresponds to the preview frame rate, in response to that a preview frame rate of the video editing draft is less than a frame rate threshold; determining at least one stuttering processing strategy according to editing feature data of the material clip; and displaying a stuttering prompt page according to the at least one stuttering processing strategy, the stuttering prompt page includes a stuttering operation control corresponding to each stuttering processing strategy, and the stuttering operation control is configured for performing a processing operation corresponding to each stuttering processing strategy.

### CROSS-REFERENCE TO RELATED APPLICATION

This application claims the priority to and benefits of the Chinese Patent Application No. 202411748424.6, which was filed on Nov. 29, 2024. The aforementioned patent application is hereby incorporated by reference in its entirety.

### TECHNICAL FIELD

Embodiments of the present invention relate to the field of computer technology, and more particularly, to a stuttering processing method, an electronic device and a non-transitory computer-readable medium.

### BACKGROUND

In the video editing scenarios, the user preview and play the video editing draft, and the phenomenon of stuttering may appear in the process of preview presentation. However, the current video editing application only has a basic play control function, and lack the capability to capture and analyze the above-mentioned stuttering issues. This, in turn increases the negative feedback on the video editing application.

### SUMMARY

The embodiments of the present invention provide a stuttering processing method, an electronic device and a non-transitory computer-readable medium, so as to solve the problem that the current video editing application lacks feedback on preview stuttering, ensure the fluency of the preview display function, and thus reduce the negative feedback on the video editing application.

An embodiment of the present invention provides a stuttering processing method, including:
in response to that a preview frame rate of a video editing draft is less than a frame rate threshold, obtaining a material clip for rendering a preview frame corresponding to the preview frame rate in the video editing draft;
determining at least one stuttering processing strategy according to editing feature data of the material clip; and
displaying a stuttering prompt page according to the at least one stuttering processing strategy, the stuttering prompt page includes a stuttering operation control corresponding to each stuttering processing strategy, the stuttering operation control being configured for performing a processing operation corresponding to each stuttering processing strategy.

An embodiment of the present invention also provides a stuttering processing apparatus, including:
a material clip obtaining module, for obtaining a material clip for rendering a preview frame corresponding to the preview frame rate in the video editing draft in response to that a preview frame rate of a video editing draft is less than a frame rate threshold;
a stuttering processing strategy determination module, for determining at least one stuttering processing strategy according to editing feature data of the material clip; and
a stuttering prompt page display module, for displaying a stuttering prompt page according to the at least one stuttering processing strategy,
the stuttering prompt page includes a stuttering operation control corresponding to each stuttering processing strategy, the stuttering operation control being configured for performing a processing operation corresponding to each stuttering processing strategy.

An embodiment of the present invention also provides an electronic device, including:
at least one processor; and
a memory communicatively coupled to the at least one processor,
the memory stores a computer program executable by the at least one processor, the computer program is executable by the at least one processor to enable the at least one processor to perform the stuttering processing method according to any of the embodiments of the present invention.

An embodiment of the present invention also provides a non-transitory computer-readable storage medium having stored thereon computer instructions for causing a processor, when performed, to implement the stuttering processing method according to any of the embodiments of the present invention.

An embodiment of the present invention also provides a computer program product including a computer program which, when performed by a processor, performs the stuttering processing method according to any of the embodiments of the present invention.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flow diagram of the stuttering processing method according to an embodiment of the present invention;

FIG. 2 is a schematic view of the stuttering prompt page according to an embodiment of the present invention;

FIG. 3 is a schematic view of another stuttering prompt page according to an embodiment of the present invention;

FIG. 4 is a flow diagram of another stuttering processing method according to an embodiment of the present invention;

FIG. 5 is a schematic view of another stuttering prompt page according to an embodiment of the present invention;

FIG. 6 is a schematic view of another stuttering prompt page according to an embodiment of the present invention;

FIG. 7 is a schematic view of the structure of the stuttering processing apparatus according to an embodiment of the present invention; and

FIG. 8 is a schematic structural diagram of an electronic device according to an embodiment of the present invention.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, in response to receive an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

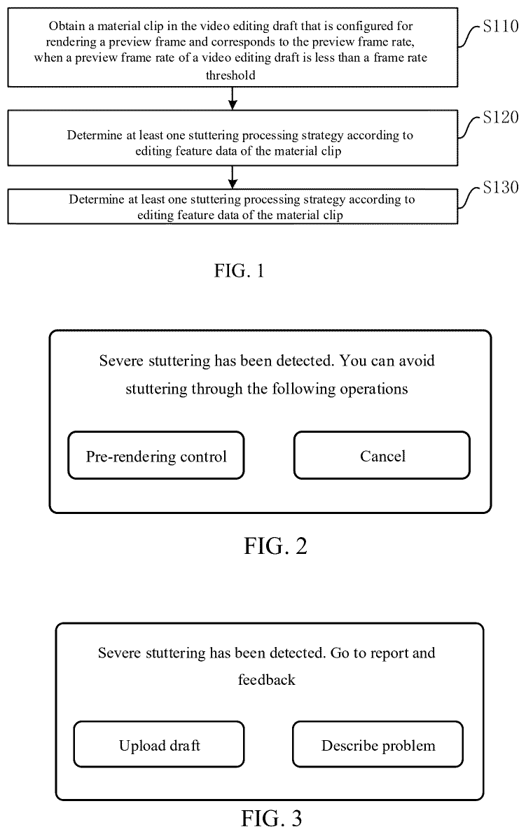

FIG. 1 is a flow diagram of the stuttering processing method according to an embodiment of the present invention. The present embodiment is applicable to the scenario of processing stuttering that occurs during a preview presentation of a video editing draft. The method may be performed by a stuttering processing apparatus, which may be implemented in hardware and/or software, and which may be configured in an electronic device, typically a mobile terminal or a tablet computer. As shown in FIG. 1, the method includes steps S110, S120 and S130.

At step S110, in response to that a preview frame rate of a video editing draft is less than a frame rate threshold, obtain a material clip in the video editing draft that is configured for rendering a preview frame and corresponds to the preview frame rate.

Specifically, the video editing draft represents the video content edited and created by a user in a video editing application, and the video editing application provides a preview tool for the video editing draft to display a preview frame sequence rendered according to the video editing draft, so that the user may view the effect presentation situation of multimedia materials such as a transition, a filter, a subtitle, a video, a picture or a sticker in the video editing draft, and check the fluency of splicing between material clips, etc.

Specifically, the preview frame rate is the number of frames of preview frames that are displayed consecutively in a unit time. Illustratively, the frame rate threshold is 24 frames/second or 30 frames/second, but is not limited to the example case.

In an alternative embodiment, the method further includes: obtaining a presentation time interval between a current preview frame and a next preview frame, and in the case where the presentation time interval is greater than a time interval threshold, taking a ratio between a unit time and the presentation time interval as a preview frame rate. Illustratively, the time interval threshold may be 66 ms, 110 ms, or 160 ms, but is not limited to the example case.

Specifically, the video editing draft includes one or more material clips, which are composed of multimedia materials such as picture frames, effects, stickers, audio, etc., and may be combined as a whole in the video editing draft for position adjustment. In the present embodiment, a material clip for rendering a preview frame and corresponding to the preview frame rate represents a material clip containing a picture frame corresponding to a preview frame related to the preview frame rate. Illustratively, the preview frame related to the preview frame rate may be the last preview frame in a series of preview frames for calculating the preview frame rate.

On the basis of the above-mentioned embodiment, optionally, after obtaining a material clip in a video editing draft that is configured for rendering a preview frame and corresponds to the preview frame rate, the method further includes: in the draft preview page, displaying a stuttering mark on the material clip.

Specifically, the draft preview page represents an interaction page for performing a preview presentation of a video editing draft. In an alternative embodiment, the draft preview page includes a preview presentation area and a functional interaction area. In particular, the preview presentation area is used for presenting a preview frame obtained by rendering according to the video editing draft, and the functional interaction area is used for defining a preview interaction control. Illustratively, the preview interaction control includes at least one of a pause control, a play control, a fast-forward control, and a backward control, etc. The draft preview page is not limited here, and may be customized according to actual requirements.

Illustratively, the marking forms for displaying a stuttering mark on the material clip includes, but is not limited to, a selected mark, a highlighted mark, adding stuttering identifier and so on. The marking forms for displaying a stuttering mark is not limited herein, and may be specifically customized according to actual requirements.

The advantage of setting the display of stuttering marks is to assist the user in understanding the stuttering that occurs during the preview presentation and provide a reference for the user to select to trigger the stuttering operation control.

At step S120, determine at least one stuttering processing strategy according to editing feature data of the material clip.

Specifically, the editing feature data is used to represent the characteristic information associated with the edit attributes of the material clips. In an alternative embodiment, the editing feature data includes at least one editing feature parameter selected from a group consisting of a clip material resolution, a clip duration, a group of pictures length, a number of effects, and a picture-in-picture hierarchy number.

Specifically, the clip material resolution is the number of pixels the material clip included in the horizontal and vertical directions, e.g., 1920×1080, representing the definition of the material clip. The clip duration is the time interval between the starting time point and the ending time point of a material clip. A group of pictures (GOP) is a set composed of a series of continuous picture frames. A group of pictures length represents the number of picture frames included in a group of pictures, and these picture frames may be divided into I frames (key frames), P frames (predicted frames) and B frames (bidirectional predicted frames), etc. The greater the group of pictures length, the higher the encoding quality of the material clip, and on the contrary, the smaller the group of pictures length, the lower the encoding quality of the material clip. The number of effects represents the number of effects added to the material clip. The effects include, but are not limited to, transition effects, filter effects, animation effects, and text effects, etc., which may be used to reflect the visual richness of the material clip. Picture-in-picture refers to embedding one or more smaller sub-pictures in a main picture so as to form a multi-level picture display effect, and the picture-in-picture hierarchy is a quantitative index for distinguishing the hierarchical relationship between different pictures.

Specifically, the stuttering processing strategy represents a solution set for the stuttering phenomenon during the previewing.

In an alternative embodiment, the determining at least one stuttering processing strategy according to editing feature data of the material clip, includes: comparing at least one editing feature parameter in the editing feature data with an editing feature condition, and determining at least one stuttering processing strategy according to the comparison result. Each editing feature parameter corresponds to a respective editing feature condition, and the comparison result indicates whether each of the editing feature parameters satisfies the editing feature conditions corresponding thereto. Specifically, according to the mapping list between the editing feature parameter and the stuttering processing strategy, the stuttering processing strategy corresponding to the editing feature parameter that does not satisfy the editing feature condition is queried.

In an alternative embodiment, the determining at least one stuttering processing strategy according to editing feature data of the material clip, includes: in response to that the number of effects in the editing feature data is greater than a number threshold, taking a pre-rendering strategy as a stuttering processing strategy. The pre-rendering strategy represents performing a pre-rendering operation on other material clips located after the material clips in the video editing draft to obtain a pre-rendered frame sequence, and the pre-rendered frame sequence are used upon previewing and displaying preview frames corresponding to the other material clips.

Specifically, the number of effects being greater than the number threshold indicates an editing feature condition corresponding to the number of effects. Illustratively, the number threshold may be 10 or 20, but is not limited to the example case.

In an alternative embodiment, the determining at least one stuttering processing strategy according to editing feature data of the material clip, includes: in response to that at least one editing feature parameter in the editing feature data satisfies an editing feature condition, taking at least one selected from a group consisting of a draft reporting strategy and a problem reporting strategy as a stuttering processing strategy. Each editing feature parameter corresponds to a respective editing feature condition.

Specifically, the at least one editing feature parameter in the editing feature data satisfying an editing feature condition, indicates that the stuttering phenomenon during the preview is caused by an unknown reason. In the present embodiment, the draft reporting strategy represents uploading the video editing draft to a stuttering processing platform, and the problem reporting strategy represents performing a display operation of a problem acquisition interface, and uploading a problem description text input by a user based on the problem acquisition interface to the stuttering processing platform.

At step S130, display a stuttering prompt page according to the at least one stuttering processing strategy.

In the present embodiment, the stuttering prompt page includes a stuttering operation control corresponding to each stuttering processing strategy, and the stuttering operation control is used for performing a processing operation corresponding to each stuttering processing strategy.

On the basis of the above-mentioned embodiment, optionally, the stuttering prompt page further includes stuttering prompt information, which is used for prompting the user to solve the stuttering phenomenon during the preview by clicking the stuttering operation control. Illustratively, the stuttering prompt information may be “Severe stuttering has been detected. You can avoid stuttering by the following operations.”

FIG. 2 is a schematic view of the stuttering prompt page according to an embodiment of the present invention. FIG. 2 illustrates the stuttering processing strategy with the pre-rendering strategy as an example. Specifically, in FIG. 2, “Severe stuttering has been detected. You can avoid stuttering through the following operations” represents a stuttering prompt information, and a “pre-rendering” control represents a stuttering operation control corresponding to the pre-rendering strategy.

In an alternative embodiment, after displaying the stuttering prompt page according to the at least one stuttering processing strategy, the method further includes: in response to a triggering operation on a stuttering operation control corresponding to a pre-rendering strategy, obtaining a preview frame sequence corresponding to the other material clips, and performing preview presentation on the preview frame sequence. The preview frame sequence is obtained according to a pre-rendered frame sequence corresponding to the other material clips.

FIG. 3 is a schematic view of another stuttering prompt page according to an embodiment of the present invention. FIG. 3 takes the stuttering processing strategy including a draft reporting strategy and a problem reporting strategy as an example. Specifically, in FIG. 3, “Severe stuttering has been detected. Go to report and feedback” represents stuttering prompt information, “Upload draft” control represents a stuttering operation control corresponding to the draft reporting strategy, and “Describe problem” control represents a stuttering operation control corresponding to the problem reporting strategy.

In an alternative embodiment, after displaying the stuttering prompt page according to the at least one stuttering processing strategy, the method further includes: in response to a triggering operation on a stuttering operation control corresponding to the draft reporting strategy, uploading the video editing draft to a stuttering processing platform.

In a further alternative embodiment, after displaying a stuttering prompt page according to the at least one stuttering processing strategy, the method further includes: in response to a triggering operation on a stuttering operation control corresponding to the problem reporting strategy, displaying a problem acquisition interface, and uploading a problem description text input by a user based on the problem acquisition interface to the stuttering processing platform.

In the technical solution of the present embodiment, by obtaining a material clip in the video editing draft that corresponds to the preview frame rate and is used for rendering a preview frame in response to that a preview frame rate of a video editing draft is less than a frame rate threshold, determining at least one stuttering processing strategy according to editing feature data of the material clip, and displaying a stuttering prompt page according to the at least one stuttering processing strategy, it can guide a user to solve a stuttering phenomenon during preview by himself via a stuttering operation control, solve the problem of the current video editing application lacking a stuttering feedback during preview, and ensure the fluency of a preview display function, which in turn, reduces the negative feedback of the video editing application.

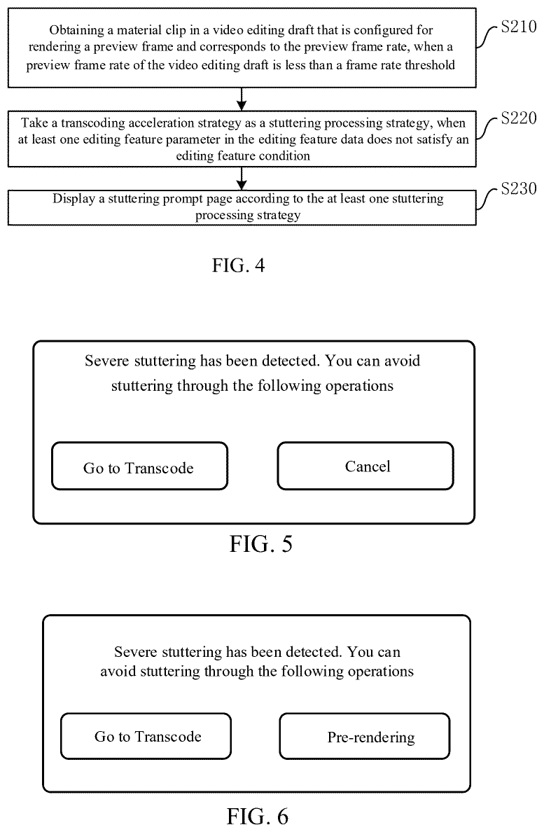

FIG. 4 is a flow diagram of another stuttering processing method according to an embodiment of the present invention. The present embodiment further refines “determining at least one stuttering processing strategy according to editing feature data of the material clip” in the above-mentioned embodiment. In the present embodiment, the determining at least one stuttering processing strategy according to editing feature data of the material clip, includes: in response to that at least one editing feature parameter in the editing feature data does not satisfy an editing feature condition, taking a transcoding acceleration strategy as a stuttering processing strategy. As shown in FIG. 4, the method includes steps S210, S220 and S230.

At step S210, in response to that a preview frame rate of a video editing draft is less than a frame rate threshold, obtain a material clip in the video editing draft that is configured for rendering a preview frame and corresponds to the preview frame rate.

The step S210 in the present embodiment is the same or similar to the step S110 shown in FIG. 1 in the above-described embodiment, and the description of the present embodiment will not be repeated here.

At step S220, in response to that at least one editing feature parameter in the editing feature data does not satisfy an editing feature condition, take a transcoding acceleration strategy as a stuttering processing strategy.

In the present embodiment, each editing feature parameters correspond to a respective editing feature condition, and the at least one editing feature parameter includes at least one selected from a group consisting of a clip material resolution, a clip duration, a group of pictures length, and a picture-in-picture hierarchy.

Specifically, the existence of at least one editing feature parameter in the editing feature data that does not satisfy the editing feature condition, indicates that the stuttering phenomenon during preview is caused by a pre-defined known cause.

In an alternative embodiment, in response to that the editing feature parameter is a clip material resolution, the editing feature condition includes that the clip material resolution is less than a resolution threshold corresponding to a material format of the material clip, and the material format is a video format or a picture format.

Illustratively, the video format includes, but are not limited to, AVI format, MPEG format, ASF format, MMV format, or MP4 format, etc., and the picture format includes, but are not limited to, PNG format, JPEG format, GIF format, or BMP format, etc.

Illustratively, the video resolution threshold may be 1080 P or 2160 P, and the picture resolution threshold may be 1920×1080 or 4096×2160. However, neither the video resolution threshold nor the picture resolution threshold is defined herein, and the setting may be customized according to actual requirements.

In an alternative embodiment, in response to that the editing feature parameter is a clip duration, the editing feature condition includes that the clip duration is greater than a duration threshold, and/or that the clip duration is less than or equal to the duration threshold and the clip continuity number of the material clip is less than a continuity number threshold. The clip continuity number represents the number of other material clips located after the material clip in the video editing draft per unit time.

Illustratively, the duration threshold may be one second or 500 milliseconds, and the continuity number threshold may be two per second or twenty per minute. However, neither the duration threshold nor the continuity number threshold is defined herein, and the specific values may be custom-set according to actual requirements.

In an alternative embodiment, the method further includes: according to a preset selection duration, obtaining other material clips located after the material clips from a video editing draft; taking the ratio between the selected number corresponding to the other material clips and the preset selected duration as the clip continuity number.

For example, assume that the clip durations of each of the other material clips located after the material clip in the video editing draft are one second, two seconds, three seconds, forty seconds, and fifty seconds in sequence. In response to that the preset selection duration is one minute, the selected number is rounded up to five, and accordingly, the clip continuity number is five per minute. In response to that the preset selection duration is thirty seconds, the selected number is rounded up to four, and accordingly, the clip continuity number is four per minute.

In a further alternative embodiment, the method further includes: according to a preset selection number, obtaining other material clips located after the material clips from a video editing draft; taking the sum of clip durations respectively corresponding to at least one other material clip as a summation duration, and taking the ratio between the preset selection number and the summation duration as a clip continuity number.

Taking the above-mentioned example as an example, in response to that the preset selection number is 3, the summation duration is six seconds, and accordingly, the clip continuity number is thirty per minute. In response to that the preset selection number is five, the summation duration is 96 seconds, and accordingly, the clip continuity number is 3.125/min.

In an alternative embodiment, in response to that the editing feature parameter is a group of pictures length, the editing feature condition includes that the group of pictures length is less than a length threshold; in response to that the editing feature parameter is a picture-in-picture hierarchy number, the editing feature condition includes that the picture-in-picture hierarchy number is less than a hierarchy number threshold.

Illustratively, the length threshold may be 30 frames, and the hierarchy number threshold may be five hierarchies, and the length threshold or the hierarchy number threshold is not limited here, and may be specifically customized according to actual requirements.

In the present embodiment, the transcoding acceleration strategy presents using a preset transcoding technique to perform a transcoding operation on the material clip and other material clips located after the material clip in the video editing draft to obtain clip transcoding data; and the clip transcoding data is used upon previewing and displaying preview frames corresponding to the material clip and the other material clips.

At step S230, display a stuttering prompt page according to the at least one stuttering processing strategy.

FIG. 5 is a schematic view of another stuttering prompt page according to an embodiment of the present invention. FIG. 5 takes an example where the stuttering processing strategy is a transcoding acceleration strategy. Specifically, in FIG. 5, “Severe stuttering has been detected. You can avoid stuttering through the following operations” represents a stuttering prompt information, and “Go to Transcode” control represents a stuttering operation control corresponding to the transcoding acceleration strategy.

On the basis of the above-mentioned embodiment, optionally, after displaying the stuttering prompt page according to the at least one stuttering processing strategy, the method further includes: obtaining a preview frame sequence corresponding to the material clip and the other material clips, and performing preview display on the preview frame sequence. The preview frame sequence is obtained according to clip transcoding data corresponding to the material clip and the other material clips.

On the basis of the above-mentioned embodiment, specifically, the determining at least one stuttering processing strategy according to editing feature data of the material clip further includes: in response to that the number of effects in the editing feature data is greater than a number threshold, taking a pre-rendering strategy as a stuttering processing strategy.

FIG. 6 is a schematic diagram of another stuttering prompt page according to an embodiment of the present invention. FIG. 6 exemplifies the stuttering processing strategy with the pre-rendering strategy and transcoding acceleration strategy as an example. Specifically, in FIG. 6, “Severe stuttering has been detected. You can avoid stuttering through the following operations” represents a stuttering prompt information. The “Pre-rendering” control represents a stuttering operation control corresponding to the pre-rendering strategy, and the “Go to Transcode” control represents a stuttering operation control corresponding to the transcoding acceleration strategy.

In the technical solution of the present embodiment, in response to that there is at least one editing feature parameter in the editing feature data which does not satisfy the editing feature condition, a transcoding acceleration strategy is taken as a stuttering processing strategy. The editing feature data includes at least one selected from a group consisting of a clip material resolution, a clip duration, a group of pictures length and a picture-in-picture hierarchy. This solves the problem of a single solution for a pre-defined known reason, and improve the diversity of the stuttering processing strategy, thereby further reducing negative feedback of a video editing application.

The following is an embodiment of the stuttering processing apparatus according to an embodiment of the present invention, which belongs to the same inventive concept as the stuttering processing method according to the above-mentioned embodiment. For details not described in detail in the embodiment of the stuttering processing apparatus, reference may be made to the details regarding the stuttering processing method in the above-mentioned embodiment.

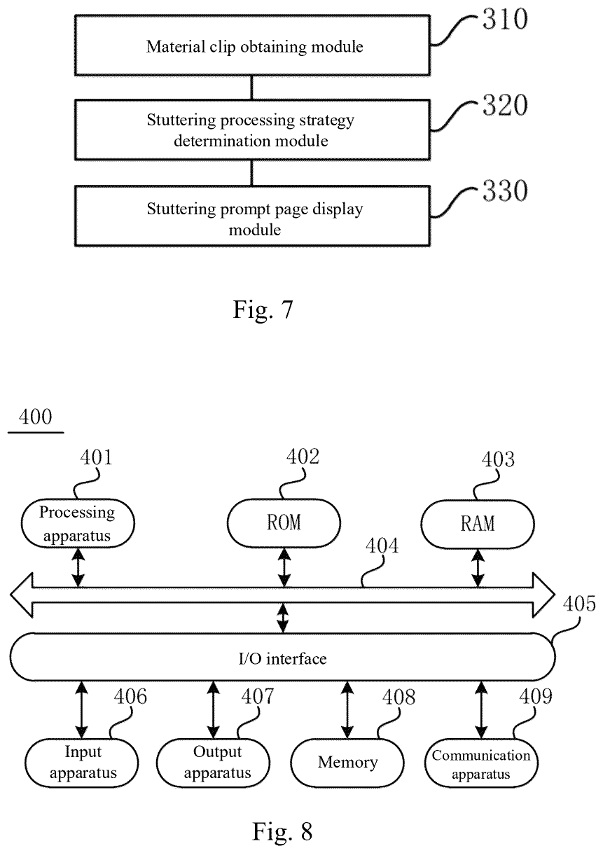

FIG. 7 is a schematic structural view of the stuttering processing apparatus according to an embodiment of the present invention. As shown in FIG. 7, the apparatus includes: a material clip obtaining module 310, a stuttering processing strategy determination module 320, and a stuttering prompt page display module 330.

The material clip acquisition module 310 is configured for obtaining a material clip in a video editing draft that is configured for rendering a preview frame and corresponds to the preview frame rate, in response to that a preview frame rate of the video editing draft is less than a frame rate threshold.

The stuttering processing strategy determination module 320 is configured for determining at least one stuttering processing strategy according to editing feature data of the material clip.

The stuttering prompt page display module 330 is configured for displaying a stuttering prompt page according to the at least one stuttering processing strategy

The stuttering prompt page includes a stuttering operation control corresponding to each stuttering processing strategy, and the stuttering operation control is configured for performing a processing operation corresponding to each stuttering processing strategy.

In the technical solution of the present embodiment, by obtaining a material clip in the video editing draft that corresponds to the preview frame rate and is used for rendering a preview frame in response to that a preview frame rate of a video editing draft is less than a frame rate threshold, determining at least one stuttering processing strategy according to editing feature data of the material clip, and displaying a stuttering prompt page according to the at least one stuttering processing strategy, it can guide a user to solve a stuttering phenomenon during preview by himself via a stuttering operation control, solve the problem of the current video editing application lacking a stuttering feedback during preview, and ensure the fluency of a preview display function, which in turn, reduces the negative feedback of the video editing application.

In an alternative embodiment, the stuttering processing strategy determination module 320 includes: a pre-rendering strategy determination unit, which is configured for taking a pre-rendering strategy as a stuttering processing strategy in response to that the number of effects in the editing feature data is greater than a number threshold.

The pre-rendering strategy represents performing a pre-rendering operation on other material clips located after the material clips in the video editing draft to obtain a pre-rendered frame sequence, and the pre-rendered frame sequence is used upon previewing and displaying preview frames corresponding to the other material clips.

In an alternative embodiment, the stuttering processing strategy determination module 320 includes: a draft reporting strategy determination unit, which is configured for taking at least one selected from a group consisting of a draft reporting strategy and a problem reporting strategy as a stuttering processing strategy in response to that at least one editing feature parameter in the editing feature data satisfies an editing feature condition.

Each editing feature parameter corresponds to a respective editing feature condition. The draft reporting strategy represents uploading the video editing draft to a stuttering processing platform. The problem reporting strategy represents performing a display operation of a problem acquisition interface, and uploading a problem description text input by a user based on the problem acquisition interface to the stuttering processing platform.

In an alternative embodiment, the stuttering processing strategy determination module 320 includes: a draft reporting strategy determination unit, which is configured for taking a transcoding acceleration strategy as a stuttering processing strategy in response to that at least one editing feature parameter in the editing feature data does not satisfy an editing feature condition.

The at least one editing feature parameter includes at least one selected from a group consisting of clip material resolution, a clip duration, a group of pictures length and a picture-in-picture hierarchy number. Each editing feature parameter corresponds to a respective editing feature condition. The transcoding acceleration strategy represents using a preset transcoding technique to perform a transcoding operation on the material clip and other material clips located after the material clip in the video editing draft to obtain clip transcoding data. The clip transcoding data is used upon previewing and displaying preview frames corresponding to the material clip and the other material clips.

In an alternative embodiment, in response to that the editing feature parameter is the clip material resolution, the editing feature condition includes that the clip material resolution is less than a resolution threshold corresponding to a material format of the material clip, and the material format is a video format or a picture format.

In an alternative embodiment, in response to that the editing feature parameter is the clip duration, the editing feature condition includes at least one selected from a group consisting of the clip duration is greater than a duration threshold, and the clip duration is less than or equal to the duration threshold and a clip continuity number of the material clip is less than a continuity number threshold.

The clip continuity number represents a number of other material clips located after the material clip in the video editing draft per unit time.

In an alternative embodiment, in response to that the editing feature parameter is the group of pictures length, the editing feature condition includes that the group of pictures length is less than a length threshold.

In response to that the editing feature parameter is the picture-in-picture hierarchy number, the editing feature condition includes that the picture-in-picture hierarchy number is less than a hierarchy number threshold.

In an alternative embodiment, the apparatus further includes:
a stuttering mark display module, which is configured for after the obtaining a material clip in a video editing draft that is configured for rendering a preview frame and corresponds to the preview frame rate, displaying a stuttering mark on the material clip in the draft preview page.

The stuttering processing apparatus according to an embodiment of the present invention can perform a stuttering processing method according to any embodiment of the present invention, and has functional modules and advantageous effects corresponding to the execution method.

Referring to FIG. 5, FIG. 5 illustrates a schematic structural diagram of an electronic device (for example a terminal device or a server) 400 suitable for implementing some embodiments of the present disclosure. The terminal device in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 8 is merely an example, and should not pose any limitation to the functions and the range of use of the embodiments of the present disclosure.

As illustrated in FIG. 8, the electronic device 400 may include a processing apparatus 401 (e.g., a central processing unit, a graphics processing unit, etc.), which can perform various suitable actions and processing according to a program stored in a read-only memory (ROM) 402 or a program loaded from a memory 408 into a random-access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a memory 408 including, for example, a magnetic tape, a hard disk, or the like; and a communication apparatus 409. The communication apparatus 409 may allow the electronic device 400 to be in wireless or wired communication with other devices to exchange data. While FIG. 5 illustrates the electronic device 400 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the memory 408, or may be installed from the ROM 402. When the computer program is executed by the processing apparatus 401, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: obtaining a material clip in a video editing draft that is configured for rendering a preview frame and corresponds to the preview frame rate in response to that a preview frame rate of the video editing draft is less than a frame rate threshold, determining at least one stuttering processing strategy according to editing feature data of the material clip; and displaying a stuttering prompt page according to the at least one stuttering processing strategy, the stuttering prompt page includes a stuttering operation control corresponding to each stuttering processing strategy, the stuttering operation control being configured for performing a processing operation corresponding to each stuttering processing strategy.

Alternatively, the above-mentioned computer readable medium carries one or more programs, and when the above-mentioned one or more programs are performed by the electronic device, the electronic device is caused to perform any of the above-mentioned stuttering processing method.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present invention, a stuttering processing method is provided, which includes:
in response to that a preview frame rate of the video editing draft is less than a frame rate threshold, obtaining a material clip in a video editing draft that is configured for rendering a preview frame and corresponds to the preview frame rate;
determining at least one stuttering processing strategy according to editing feature data of the material clip; and
displaying a stuttering prompt page according to the at least one stuttering processing strategy.

The stuttering prompt page includes a stuttering operation control corresponding to each stuttering processing strategy, and the stuttering operation control is configured for performing a processing operation corresponding to each stuttering processing strategy.

According to one or more embodiments of the present invention, the determining at least one stuttering processing strategy according to editing feature data of the material clip, includes: in response to that the number of effects in the editing feature data is greater than a number threshold, taking a pre-rendering strategy as a stuttering processing strategy;

The pre-rendering strategy represents performing a pre-rendering operation on other material clips located after the material clips in the video editing draft to obtain a pre-rendered frame sequence. The pre-rendered frame sequence is used upon previewing and displaying preview frames corresponding to the other material clips.

According to one or more embodiments of the present invention, the determining at least one stuttering processing strategy according to editing feature data of the material clip, includes: in response to that at least one editing feature parameter in the editing feature data satisfies an editing feature condition, taking at least one selected from a group consisting of a draft reporting strategy and a problem reporting strategy as a stuttering processing strategy.

Each editing feature parameter corresponds to a respective editing feature condition. The draft reporting strategy represents uploading the video editing draft to a stuttering processing platform. The problem reporting strategy represents performing a display operation of a problem acquisition interface, and uploading a problem description text input by a user based on the problem acquisition interface to the stuttering processing platform.

According to one or more embodiments of the present invention, the determining at least one stuttering processing strategy according to editing feature data of the material clip includes: in response to that at least one editing feature parameter in the editing feature data does not satisfy an editing feature condition, taking a transcoding acceleration strategy as a stuttering processing strategy.

The at least one editing feature parameter includes at least one selected from a group consisting of clip material resolution, a clip duration, a group of pictures length and a picture-in-picture hierarchy number. Each editing feature parameter corresponds to a respective editing feature condition. The transcoding acceleration strategy represents using a preset transcoding technique to perform a transcoding operation on the material clip and other material clips located after the material clip in the video editing draft to obtain clip transcoding data. The clip transcoding data is used upon previewing and displaying preview frames corresponding to the material clip and the other material clips

According to one or more embodiments of the present invention, in response to that the editing feature parameter is the clip material resolution, the editing feature condition includes the clip material resolution is less than a resolution threshold corresponding to a material format of the material clip. The material format is a video format or a picture format.

According to one or more embodiments of the present invention, in response to that the editing feature parameter is the clip duration, the editing feature condition includes at least one selected from a group consisting of the clip duration is greater than a duration threshold, and the clip duration is less than or equal to the duration threshold and a clip continuity number of the material clip is less than a continuity number threshold.

The clip continuity number represents a number of other material clips located after the material clip in the video editing draft per unit time.

According to one or more embodiments of the present invention, in response to that the editing feature parameter is the group of pictures length, the editing feature condition includes that the group of pictures length is less than a length threshold.

In response to that the editing feature parameter is the picture-in-picture hierarchy number, the editing feature condition includes that the picture-in-picture hierarchy number is less than a hierarchy number threshold.

According to one or more embodiments of the present invention, after the obtaining a material clip in a video editing draft that is configured for rendering a preview frame and corresponds to the preview frame rate, the method further includes: in the draft preview page, displaying a stuttering mark on the material clip.

According to one or more embodiments of the present invention, a stuttering processing method is provided, which includes:
a material clip acquisition module, configured for obtaining a material clip in a video editing draft that is configured for rendering a preview frame and corresponds to the preview frame rate, in response to that a preview frame rate of the video editing draft is less than a frame rate threshold;
a stuttering processing strategy determination module, configured for determining at least one stuttering processing strategy according to editing feature data of the material clip;
a stuttering prompt page display module, configured for displaying a stuttering prompt page according to the at least one stuttering processing strategy;
the stuttering prompt page includes a stuttering operation control corresponding to each stuttering processing strategy, the stuttering operation control being configured for performing a processing operation corresponding to each stuttering processing strategy.

In accordance with one or more embodiments of the present invention, an electronic device is provided, which includes:
at least one processor; and
a memory communicatively coupled to the at least one processor,
the memory stores a computer program executable by the at least one processor, the computer program being performed by the at least one processor to enable the at least one processor to perform any of the above stuttering processing methods.

According to one or more embodiments of the present invention, a non-transitory computer-readable storage medium storing computer instructions for causing a processor, when performed, to implement any of the above stuttering processing methods.

According to one or more embodiments of the present invention, a computer program product including a computer program that, when performed by a processor, implements any of the above stuttering processing methods.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A stuttering processing method, comprising:
in response to that a preview frame rate of the video editing draft is less than a frame rate threshold, obtaining a material clip in a video editing draft that is configured for rendering a preview frame and corresponds to the preview frame rate;
determining at least one stuttering processing strategy according to editing feature data of the material clip; and
displaying a stuttering prompt page according to the at least one stuttering processing strategy,
wherein the stuttering prompt page comprises a stuttering operation control corresponding to each stuttering processing strategy, the stuttering operation control being configured for performing a processing operation corresponding to each stuttering processing strategy.

2. The stuttering processing method according to claim 1, wherein the determining at least one stuttering processing strategy according to editing feature data of the material clip, comprises:
in response to that a number of effects in the editing feature data is greater than a number threshold, taking a pre-rendering strategy as a stuttering processing strategy,
wherein the pre-rendering strategy represents performing a pre-rendering operation on other material clips located after the material clips in the video editing draft to obtain a pre-rendered frame sequence, and the pre-rendered frame sequence being used upon previewing and displaying preview frames corresponding to the other material clips.

3. The stuttering processing method according to claim 1, wherein the determining at least one stuttering processing strategy according to editing feature data of the material clip, comprises:
in response to that at least one editing feature parameter in the editing feature data satisfies an editing feature condition, taking at least one selected from a group consisting of a draft reporting strategy and a problem reporting strategy as a stuttering processing strategy,
wherein each editing feature parameter corresponds to a respective editing feature condition,
wherein the draft reporting strategy represents uploading the video editing draft to a stuttering processing platform, and
wherein the problem reporting strategy represents performing a display operation of a problem acquisition interface, and uploading a problem description text input by a user based on the problem acquisition interface to the stuttering processing platform.

4. The stuttering processing method according to claim 1, wherein the determining at least one stuttering processing strategy according to editing feature data of the material clip, comprises:
in response to that at least one editing feature parameter in the editing feature data does not satisfy an editing feature condition, taking a transcoding acceleration strategy as a stuttering processing strategy,
wherein the at least one editing feature parameter comprises at least one selected from a group consisting of a clip material resolution, a clip duration, a group of pictures length and a picture-in-picture hierarchy number,
wherein each editing feature parameter corresponds to a respective editing feature condition, and
wherein the transcoding acceleration strategy represents using a preset transcoding technique to perform a transcoding operation on the material clip and other material clips located after the material clip in the video editing draft to obtain clip transcoding data, the clip transcoding data being used upon previewing and displaying preview frames corresponding to the material clip and the other material clips.

5. The stuttering processing method according to claim 4, wherein in response to that the editing feature parameter is the clip material resolution, the editing feature condition comprises the clip material resolution is less than a resolution threshold corresponding to a material format of the material clip, the material format being a video format or a picture format.

6. The stuttering processing method according to claim 4, wherein in response to that the editing feature parameter is the clip duration, the editing feature condition comprises at least one selected from a group consisting of the clip duration is greater than a duration threshold, and the clip duration is less than or equal to the duration threshold and a clip continuity number of the material clip is less than a continuity number threshold, and
wherein the clip continuity number represents a number of other material clips located after the material clip in the video editing draft per unit time.

7. The stuttering processing method according to claim 4, wherein in response to that the editing feature parameter is the group of pictures length, the editing feature condition comprises that the group of pictures length is less than a length threshold, and
in response to that the editing feature parameter is the picture-in-picture hierarchy number, the editing feature condition comprises that the picture-in-picture hierarchy number is less than a hierarchy number threshold.

8. The stuttering processing method according to claim 1, wherein after the obtaining a material clip in a video editing draft that is configured for rendering a preview frame and corresponds to the preview frame rate, the method further comprises:
in the draft preview page, displaying a stuttering mark on the material clip.

9. An electronic device, comprising:
at least one processor; and
a memory communicatively coupled to the at least one processor,
wherein the memory stores a computer program executable by the at least one processor, when the computer program is performed by the at least one processor, the at least one processor is enabled to perform the stuttering processing method, and
wherein the stuttering processing method comprises:
obtaining a material clip in a video editing draft that is configured for rendering a preview frame and corresponds to the preview frame rate in response to that a preview frame rate of the video editing draft is less than a frame rate threshold;
determining at least one stuttering processing strategy according to editing feature data of the material clip; and
displaying a stuttering prompt page according to the at least one stuttering processing strategy,
wherein the stuttering prompt page comprises a stuttering operation control corresponding to each stuttering processing strategy, the stuttering operation control being configured for performing a processing operation corresponding to each stuttering processing strategy.

10. The electronic device according to claim 9, wherein the determining at least one stuttering processing strategy according to editing feature data of the material clip, comprises:
in response to that a number of effects in the editing feature data is greater than a number threshold, taking a pre-rendering strategy as a stuttering processing strategy,
wherein the pre-rendering strategy represents performing a pre-rendering operation on other material clips located after the material clips in the video editing draft to obtain a pre-rendered frame sequence, and the pre-rendered frame sequence being used upon previewing and displaying preview frames corresponding to the other material clips.

11. The electronic device according to claim 9, wherein the determining at least one stuttering processing strategy according to editing feature data of the material clip, comprises:
in response to that at least one editing feature parameter in the editing feature data satisfies an editing feature condition, taking at least one selected from a group consisting of a draft reporting strategy and a problem reporting strategy as a stuttering processing strategy,
wherein each editing feature parameter corresponds to a respective editing feature condition,
wherein the draft reporting strategy represents uploading the video editing draft to a stuttering processing platform, and
wherein the problem reporting strategy represents performing a display operation of a problem acquisition interface, and uploading a problem description text input by a user based on the problem acquisition interface to the stuttering processing platform.

12. The electronic device according to claim 9, wherein the determining at least one stuttering processing strategy according to editing feature data of the material clip, comprises:
in response to that at least one editing feature parameter in the editing feature data does not satisfy an editing feature condition, taking a transcoding acceleration strategy as a stuttering processing strategy,
wherein the at least one editing feature parameter comprises at least one selected from a group consisting of a clip material resolution, a clip duration, a group of pictures length and a picture-in-picture hierarchy number,
wherein each editing feature parameter corresponds to a respective editing feature condition, and
wherein the transcoding acceleration strategy represents using a preset transcoding technique to perform a transcoding operation on the material clip and other material clips located after the material clip in the video editing draft to obtain clip transcoding data, the clip transcoding data being used upon previewing and displaying preview frames corresponding to the material clip and the other material clips.

13. The electronic device according to claim 12, wherein in response to that the editing feature parameter is the clip material resolution, the editing feature condition comprises the clip material resolution is less than a resolution threshold corresponding to a material format of the material clip, the material format being a video format or a picture format.

14. The electronic device according to claim 12, wherein in response to that the editing feature parameter is the clip duration, the editing feature condition comprises at least one selected from a group consisting of the clip duration is greater than a duration threshold, and the clip duration is less than or equal to the duration threshold and a clip continuity number of the material clip is less than a continuity number threshold, and
wherein the clip continuity number represents a number of other material clips located after the material clip in the video editing draft per unit time.

15. The electronic device according to claim 12, wherein in response to that the editing feature parameter is the group of pictures length, the editing feature condition comprises the group of pictures length is less than a length threshold, and
in response to that the editing feature parameter is the picture-in-picture hierarchy number, the editing feature condition comprises the picture-in-picture hierarchy number is less than a hierarchy number threshold.

16. The electronic device according to claim 9, wherein after the obtaining a material clip in a video editing draft that is configured for rendering a preview frame and corresponds to the preview frame rate, the method further comprises:
in the draft preview page, displaying a stuttering mark on the material clip.

17. A non-transitory computer-readable storage medium, having stored thereon computer instructions for causing a processor, when performed, to implement a stuttering processing method,
wherein the stuttering processing method comprises:
obtaining a material clip in a video editing draft that is configured for rendering a preview frame and corresponds to the preview frame rate in response to that a preview frame rate of the video editing draft is less than a frame rate threshold;
determining at least one stuttering processing strategy according to editing feature data of the material clip; and
displaying a stuttering prompt page according to the at least one stuttering processing strategy,
wherein the stuttering prompt page comprises a stuttering operation control corresponding to each stuttering processing strategy, the stuttering operation control being configured for performing a processing operation corresponding to each stuttering processing strategy.

18. The non-transitory computer-readable storage medium according to claim 17, wherein the determining at least one stuttering processing strategy according to editing feature data of the material clip, comprises:
in response to that a number of effects in the editing feature data is greater than a number threshold, taking a pre-rendering strategy as a stuttering processing strategy,
wherein the pre-rendering strategy represents performing a pre-rendering operation on other material clips located after the material clips in the video editing draft to obtain a pre-rendered frame sequence, and the pre-rendered frame sequence being used upon previewing and displaying preview frames corresponding to the other material clips.

19. The non-transitory computer-readable storage medium according to claim 17, wherein the determining at least one stuttering processing strategy according to editing feature data of the material clip, comprises:
in response to that at least one editing feature parameter in the editing feature data satisfies an editing feature condition, taking at least one selected from a group consisting of a draft reporting strategy and a problem reporting strategy as a stuttering processing strategy,
wherein each editing feature parameter corresponds to a respective editing feature condition,
wherein the draft reporting strategy represents uploading the video editing draft to a stuttering processing platform, and
wherein the problem reporting strategy represents performing a display operation of a problem acquisition interface, and uploading a problem description text input by a user based on the problem acquisition interface to the stuttering processing platform.

20. The non-transitory computer-readable storage medium according to claim 17, wherein the determining at least one stuttering processing strategy according to editing feature data of the material clip, comprises:
in response to that at least one editing feature parameter in the editing feature data does not satisfy an editing feature condition, taking a transcoding acceleration strategy as a stuttering processing strategy,
wherein the at least one editing feature parameter comprises at least one selected from a group consisting of a clip material resolution, a clip duration, a group of pictures length and a picture-in-picture hierarchy number,
wherein each editing feature parameter corresponds to a respective editing feature condition,
wherein the transcoding acceleration strategy represents using a preset transcoding technique to perform a transcoding operation on the material clip and other material clips located after the material clip in the video editing draft to obtain clip transcoding data, the clip transcoding data being used upon previewing and displaying preview frames corresponding to the material clip and the other material clips.
